(19) United States
(12) Patent Application Publication
(10) Pub. No.: US 2011/0005153 A1
(43) Pub. Date: Jan. 13, 2011

(54) Window and Trim Assembly and Method

(76) Inventor: Edward L. Schield, Medford, WI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/867,533

(22) PCT Filed: Feb. 13, 2008
(86) PCT No.: PCT/US08/53842

§ 371 Date: Aug. 13, 2010

(51) Int. Cl. E06B 1/04; E04B 1/00

(52) U.S. Cl. 52/204.53; 52/741.1

(57) ABSTRACT

An improved window and trim assembly that facilitates quick and easy installation of a trim assembly on a window includes a window or door unit having a casing that defines a plurality of clip receiving grooves, a plurality of resilient clips receivable in the clip receiving grooves, and a pre-assembled trim cover retained on the window or door unit by the resilient clips. Attachment of the exterior trim cover to the window or door unit involves inserting clips into the grooves and pushing the cover onto the window or door unit until features on the trim cover engage the clips.

### FIELD OF THE INVENTION

This invention relates to windows and doors, trim assemblies for windows and doors, and related processes for trimming a window or door.

### BACKGROUND OF THE INVENTION

In both new building construction and during renovations, remodeling or other reconstruction activities involving replacement of a building window, it is often desirable to provide the window with an exterior trim that conceals a gap between interfacing edges of the window and the exterior siding or other finish material used to protect the building against the affects of weather and/or to provide a desired ornamental effect. Exterior window trimming has generally involved the use of several individual components that are separately fastened to the building wall and/or the window.

U.S. Pat. No. 4,193,238 discloses a snap-on exterior cover or trim system for window casings. The system includes a plurality of case molding members adapted to be disposed around the window opening in engagement with each other, a plurality of brackets securable to a window casing, and fastening means for each bracket. In an illustrated embodiment, eight individual brackets are separately fastened to the window casing with screws. The bracket includes a base with a slotted opening, and a helical spring is disposed over the screw between the base and the head of the screw to allow adjustable repositioning of the brackets as needed for installation. The plurality of case molding members are adapted to be attached to the brackets using a snap-on or interference connection.

### SUMMARY OF THE INVENTION

In accordance with an aspect of the invention, a window or door and trim assembly that allows easy and secure attachment of an exterior window or door trim to a window frame is provided. The assembly includes a window or door having a casing or frame that defines a clip receiving groove, a plurality of resilient clips receivable in a clip receiving groove, and a pre-assembled trim cover retainable on the window or door casing or frame by snap-on attachment of the trim cover to the resilient clips.

In accordance with another aspect of the invention, a method of installing an exterior trim assembly to a window or door casing or frame is provided. The method includes steps of providing a window or door casing or frame defining clip receiving grooves, inserting resilient clips into the clip receiving grooves, and attaching a pre-assembled trim cover to the window or door casing or frame employing a snap-on connection between the pre-assembled trim cover and the resilient clips.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a window and exterior trim assembly in accordance with an illustrated embodiment of the invention.

FIG. 2 is a transverse cross-sectional view or profile of a resilient clip used for holding an exterior trim cover to a window unit in accordance with an illustrated embodiment of the invention.

FIG. 3 is a schematic horizontal cross-sectional view of a completed assembly as illustrated in FIG. 1.

FIG. 4 is an enlarged schematic horizontal cross-sectional view showing details of the connection between the resilient clip, the window unit, and the exterior trim cover.

### DETAILED DESCRIPTION OF PREFERRED EMBODIMENTS

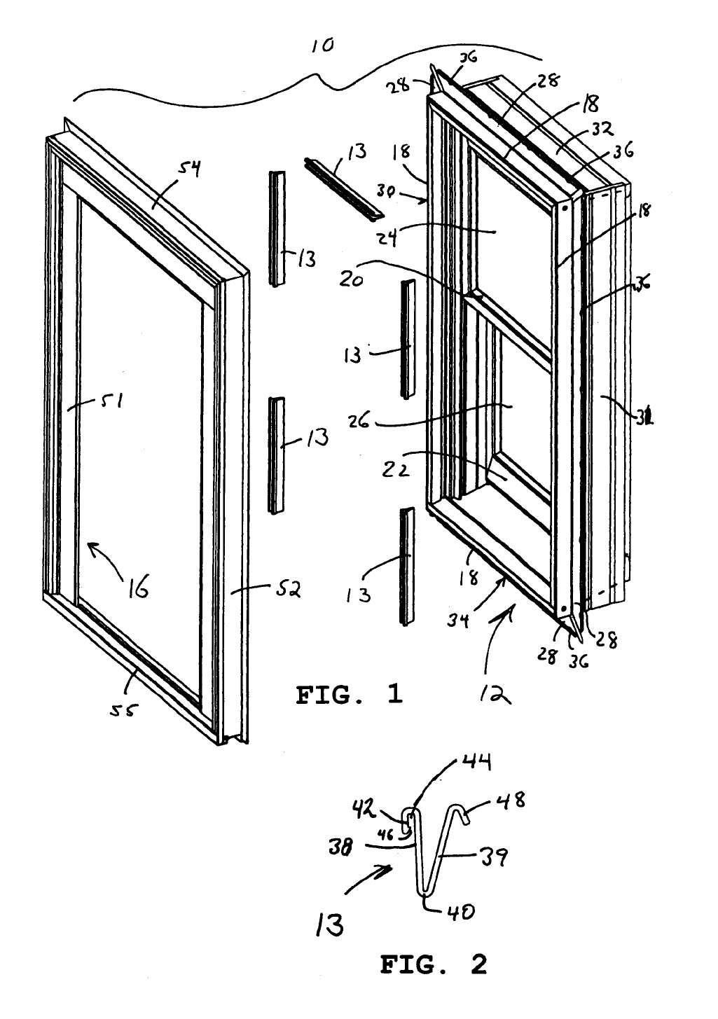

A window and exterior trim assembly 10 in accordance with the invention is shown in FIG. 1. The assembly includes a window unit 12, a plurality of resilient clips 13, and a one-piece, pre-assembled exterior trim cover 16. In the illustrated embodiment, window unit 12 is a double-hung window of generally conventional design except for the inclusion of clip receiving grooves 18 defined in the various frame members that support upper sash frame 20 and lower sash frame 22 for upward and downward movement. Sash frames 20 and 22 frame and retain upper window pane 24 and lower window pane 26, respectively. While the illustrated embodiment is a double-hung window, window unit 12 may be generally any type of window that forms single or multiple window panes (e.g., glass, plastic or other light transmissive sheet-like material), whether openable, pivotable, slideable or stationary (not openable), including roof windows or skylights, as well as doors.

In the illustrated embodiment, window unit 12 includes nailing fins 28 that extend outwardly from opposite sides of the window frame and from the top and bottom of the window frame to facilitate nailing, screwing, or tacking of the fins to wood studs or other building structure to facilitate proper positioning and orientation of the window in a building opening. However, as is conventional in the art, the various frame members, including side members or jambs 30, top member or header 32, and bottom member or sill 34 may subsequently be securely attached to wood studs or other building structure to secure window unit 12 in a building opening. In order to facilitate nailing, screwing or tacking of nailing fins 28 to a building structure, nailing fins 28 may be provided with preformed fastener apertures 36.

The various frame components employed in window unit 12 may be made of any suitable material, including wood, metal, (e.g., aluminum), metal clad framing (e.g., aluminum clad wood material), etc.

Resilient clips 13 are configured to be securely retained in a clip receiving groove 18, by manually inserting a portion of clip 13 into groove 18. Clips 13 are also configured to cooperate with complementary features defined on exterior trim cover 16 to securely hold exterior trim cover 16 on widow unit 12 when exterior trim cover 16 is properly aligned with window unit 12 and pushed into engagement with clips 13 received in grooves 18 of window unit 12. Resilient clips 13 are also configured and made of a material that allows easy deformation of certain features of the clip with respect to other features of the clip during the process of attaching the exterior trim cover 16 to the window unit 12, and subsequent resilient recovery to its original form after full attachment of cover 16 to window unit 12, whereby an interference connection or snap-on connection is employed to securely hold exterior trim cover 16 on window unit 12 via resilient clips 13.

A transverse cross section or profile of a resilient clip 13 in accordance with the illustrated embodiment of the invention is shown in FIG. 2. In profile, clip 13 has a generally V-shaped configuration in which an inner leg 38 is connected to an outer leg 39 at vertex 40. Legs 38 and 39 are able to flex with respect to each other around vertex 40 when compressive forces are applied to legs 38 and 39. However, when the force is removed, clip 13 exhibits sufficient resilience to return to its original form. Various resiliently deformable plastic and metal materials may be employed for making clip 13. In general, extruded plastics are preferred, with extruded polyvinyl chloride clips being particularly preferred for their suitability and economy. Illustrated clip 13 also includes a generally L-shaped foot 42 that extends from an end of leg 38 opposite vertex 40. More specifically, foot 42 extends approximately at a right angle away from the inner side (side closest the window pane after installation is complete) of inner leg 38 and then generally at a right angle parallel to and spaced from the inner side of inner leg 38 to define a channel or groove 44 between inner foot 42 and inner leg 38. At the distal end of inner foot 42, there is provided a barb 46 having a pointed end facing toward the inner side of inner leg 38. At an end of outer leg 39 opposite vertex 40, an outer foot 48 extends outwardly at an acute angle from the outer side of outer leg 39.

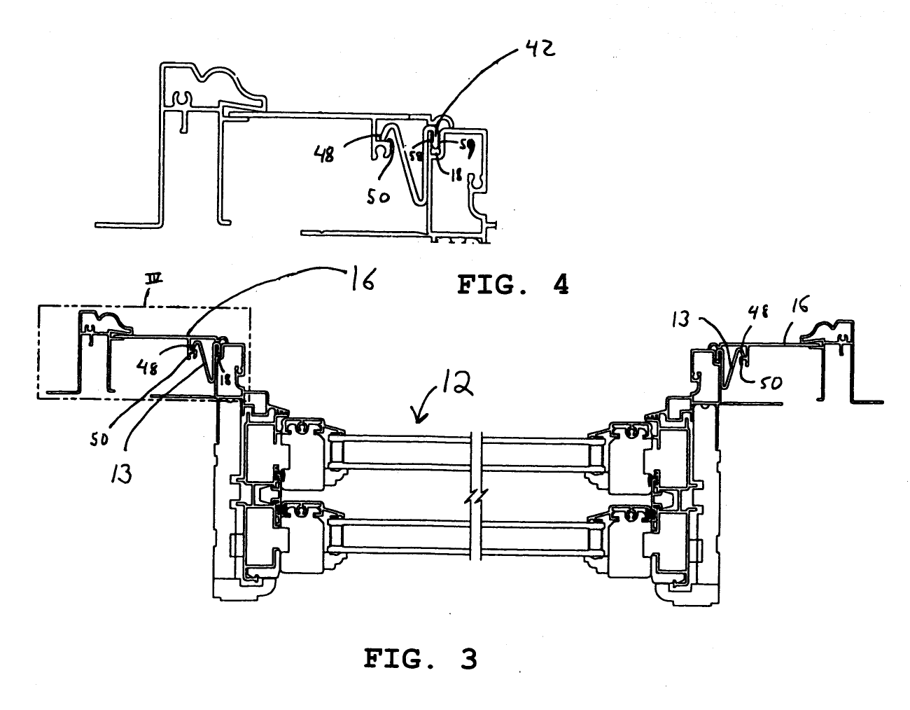

FIG. 3 shows a schematic horizontal cross section of the illustrated assembly shown in FIG. 1. When the assembly is completed, inner foot 42 is retained in groove 18, and exterior trim cover 16 is held in place by outer feet 48 engaging a retainment landing feature 50 defined on exterior trim cover 16 along each of the side members 51 and 52, and along the top member 54. Similar features may be provided along bottom member 55, and a resilient clip 13 may be used for connecting a clip 13 in groove 18 of sill 34 and to bottom member 55 of exterior trim cover 16. However, in the illustrated embodiment only five clips 13 are used and illustrated, including two at each side, and one along the top of window unit 12. In some cases it may be possible to use as few as two clips 13 (one on each side).

An enlarged schematic cross-sectional view illustrating details of the connection between resilient clip 13 and window unit 12, and between resilient clip 13 and exterior trim cover 16 is shown in FIG. 4. Groove 18 in window unit 12 includes kerfs or serrations 58 and 59 that engage inner foot 42 to securely retain foot 42 in groove 18, with engagement of barb 46 on inner foot 42 with a serration 58 providing secure attachment of clip 13 to a window unit 12.

In accordance with certain aspects of this invention, exterior trim cover 16 is preferably provided in the form of a pre-assembled, one-piece unit in which members 51, 52, 54 and 55 are connected together as shown in FIG. 1. Such connection can be achieved with fasteners, such as screws, nails, bolts, rivets or the like, adhesives, welding, or any other suitable means, which may depend on the material used for making the components of the exterior trim cover 16. Preferably, for reasons of efficiency and economy, members 51, 52, 54 and 55 are extruded metal or plastic, with extruded aluminum being a particularly preferred alternative. However, it is conceivable that the entire exterior trim cover 16 can be formed as a single unit, such as in an injection molding process.

In accordance with various aspects of the invention, there is provided a quick and simple technique or method for installing an exterior trim on a window unit. The method involves using a window unit, resilient clips, and an exterior trim cover as generally described herein. In the illustrated embodiment, after window unit 12 has been installed in a building opening employing generally conventional techniques, clips 13 are inserted at various locations into grooves defined along a front exterior face of window unit 12. In the illustrated example, the installer need merely insert an inner foot 32 of each of five clips 13 into grooves 18 as generally indicated in FIG. 1, with the foot being fully inserted as illustrated in FIG. 4. Thereafter, a pre-assembled exterior trim cover is aligned with the window unit 12 and pushed into engagement with clips 13 so that outer feet 48 engage landings 50, at least along opposite sides of the window unit, whereby an interference connection is achieved.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A window or door and exterior trim assembly, comprising:
a window or door unit having a casing defining a plurality of clip receiving grooves;
a plurality of resilient clips received in the clip receiving grooves; and
a trim cover retained on the window unit by the resilient clips.

2. The assembly of claim 1, wherein the resilient clips are comprised of a plastic material.

3. The assembly of claim 1, wherein the resilient clips are comprised of polyvinyl chloride.

4. The assembly of claim 1, wherein the clips have a resilient compressible configuration that allows compressive flexing of the clip during attachment of the trim cover and resilient decompression thereafter to lock the trim cover onto the window or door unit after it has been fully inserted onto the window unit.

5. The assembly of claim 1, wherein each clip receiving groove defines serrations that facilitate insertion of a foot of a resilient clip into the groove and resists withdrawal of the foot from the groove.

6. The assembly of claim 1, wherein each resilient clip has a generally V-shaped profile including an inner leg and an outer leg connected at a vertex, an inner foot extending inwardly toward the window or door and partially back along the inner leg toward the vertex, and an outer foot extending generally at an acute angle away from the outer leg toward a landing on the trim cover.

7. The assembly of claim 6, wherein the inner foot includes a barb that engages a serration defined in the groove of the window or door unit.

8. The assembly of claim 1, wherein the trim cover is an exterior trim cover.

9. The assembly of claim 1, wherein the trim cover is made of aluminum.

10. The assembly of claim 1, wherein the window or door unit includes nailing fins projecting from the casing to facilitate securement of the window or door unit to building structure.

11. A method of trimming a building window or door, comprising steps of:
providing a window or door unit having a casing defining clip receiving grooves;
inserting resilient clips into the clip receiving grooves; and
retaining a trim cover on the window or door unit by employment of an interference connection between the clips and the trim cover.

12. The method of claim 11, wherein the resilient clips are comprised of a plastic material.

13. The method of claim 11, wherein the resilient clips are comprised of polyvinyl chloride.

14. The method of claim 11, wherein the clips have a resilient compressible configuration that allows compressive flexing of the clip during attachment of the trim cover and resilient decompression thereafter to lock the trim cover onto the window or door unit after it has been fully inserted onto the window unit.

15. The method of claim 11, wherein each clip receiving groove defines serrations that facilitate insertion of a foot of a resilient clip into the groove and resists withdrawal of the foot from the groove.

16. The method of claim 11, wherein each resilient clip has a generally V-shaped profile including an inner leg and an outer leg connected at a vertex, an inner foot extending inwardly toward the window or door and partially back along the inner leg toward the vertex, and an outer foot extending generally at an acute angle away from the outer leg toward a landing on the trim cover.

17. The method of claim 16, wherein the inner foot includes a barb that engages a serration defined in the groove of the window or door unit.

18. The method of claim 11, wherein the trim cover is an exterior trim cover.

19. The method of claim 11, wherein the trim cover is made of aluminum.

20. The method of claim 11, wherein the window or door unit includes nailing fins projecting from the casing to facilitate securement of the window or door unit to building structure.
